(19) United States
(12) Patent Application Publication
(10) Pub. No.: US 2019/0241262 A1
(43) Pub. Date: Aug. 8, 2019

(54) HYPERSONIC VEHICLE USING SCRAMJET

(71) Applicant: Khaled Abdullah Alhussan, Riyadh (SA)

(72) Inventor: Khaled Abdullah Alhussan, Riyadh (SA)

(21) Appl. No.: 16/269,515

(22) Filed: Feb. 6, 2019

Related U.S. Application Data
(63) Continuation of application No. 62/626,861, filed on Feb. 6, 2018.

(51) Int. Cl. B64C 30/00; B64D 27/02; B64D 27/20; B64D 27/18; F02K 7/14; F02K 7/08

(52) U.S. Cl. CPC B64C 30/00; B64D 27/02; B64D 27/20; B64D 2027/026; F02K 7/14; F02K 7/08; B64D 27/18

(57) ABSTRACT

A hypersonic vehicle includes a body; a first engine secured to the body, the first engine is configured to create forward thrust at a first flight regime; a second engine secured to the body, the second engine is configured to create forward thrust at a second flight regime; and the hypersonic vehicle transitions between the first engine and the second engine during the first flight regime and the second flight regime.

### BACKGROUND

### 1. Field of the Invention

The invention relates to generally to hypersonic vehicles, for example, an aircraft having a hypersonic propulsion system configured to provide forward thrust during flight. More specifically, the present invention discusses a hypersonic vehicle utilizing a first engine to create forward thrust along with a scramjet propulsion system.

### 2. Description of Related Art

Conventional aircraft, as shown in FIG. 1, are well known in the art and provide effective means to transport persons and/or other forms of cargo from a first location to a second location. As depicted, the process 101 includes utilizing an aircraft 103 having one or more jet engines 105 configured to create forward thrust and lift during different flight regimes. Although effective in most applications of use, there are limitations of use when utilizing aircraft 103 at different flight regimes.

For example, it should be understood that the conventional jet engines 105 are typically configured to achieve optimal flight performance after the aircraft reaches a height 107 along trajectory path 1A-1B. Prior to reaching elevation 107, the jet engines 105 are not operating at optimal efficiency during the initial flight regime, which in turn results in exhausted fuel and costs. Another problem commonly associated with aircraft 103 is that engines 105 reach a thrust limitation that creates forward flight below M=1, which in turn results in longer flight times, added fuel usage, and costs.

Although great strides have been made in the art many shortcomings remain. Accordingly, there is a need for a supersonic vehicle that overcomes the limitations found in the present art.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a schematic of a conventional aircraft during different flight regimes;

FIGS. 2A, 2B and 3 are schematics of a system and method of the aircraft in accordance to a preferred embodiment of the present invention;

FIG. 4 is a cross-sectional side view of the scramjet engine of the system of the present invention; and

FIG. 5 is an alternative embodiment of the present invention.

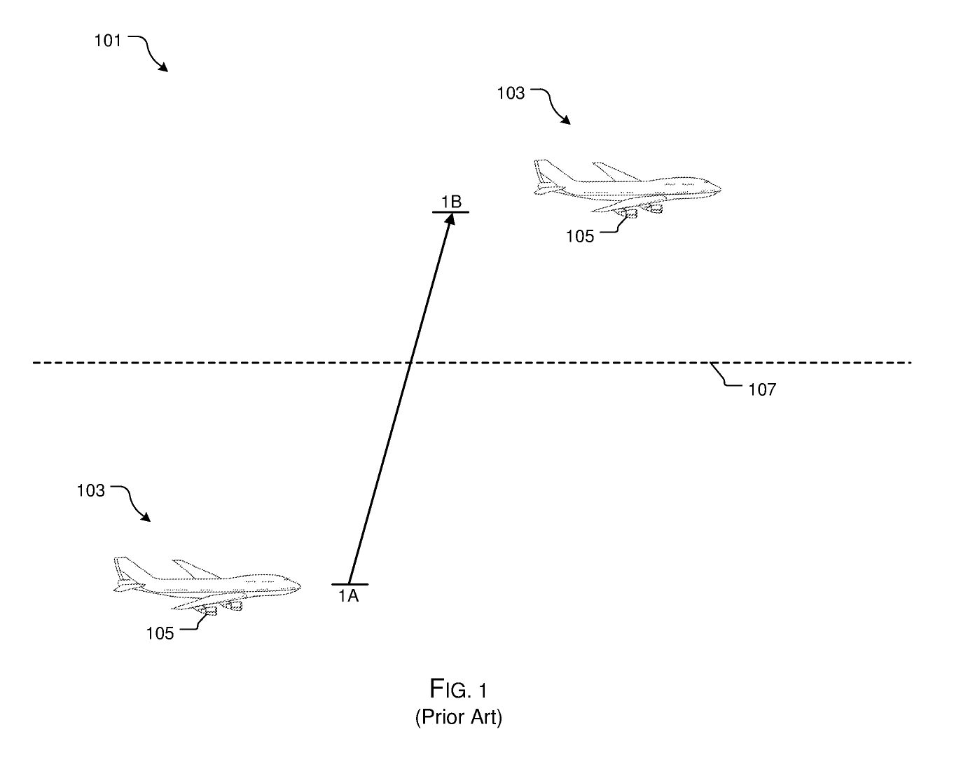

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

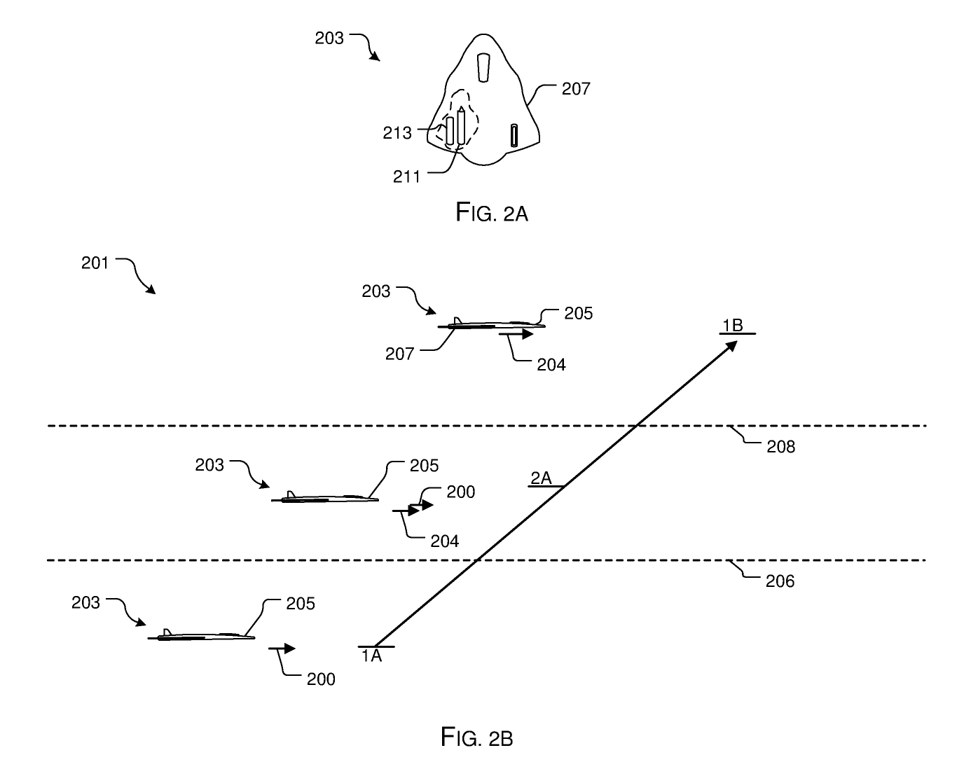

Referring now to the drawings wherein like reference characters identify corresponding or similar elements throughout the several views, FIGS. 2-5 depict various views and embodiments of a supersonic vehicle using scramjet technology. It should be understood that the embodiments discussed herein are substantially similar in form and function and share one or more of the features discussed in each embodiment although the features may not be shown specifically with reference to the particular embodiment. It will be appreciated that the systems 201 and 501 discussed herein overcome one of more of the problems commonly associated with conventional aircraft as discussed above. Although the drawings and description thereof are shown with a jet aircraft, it will be appreciated that the features discussed herein could be utilized with different types of flight vehicles.

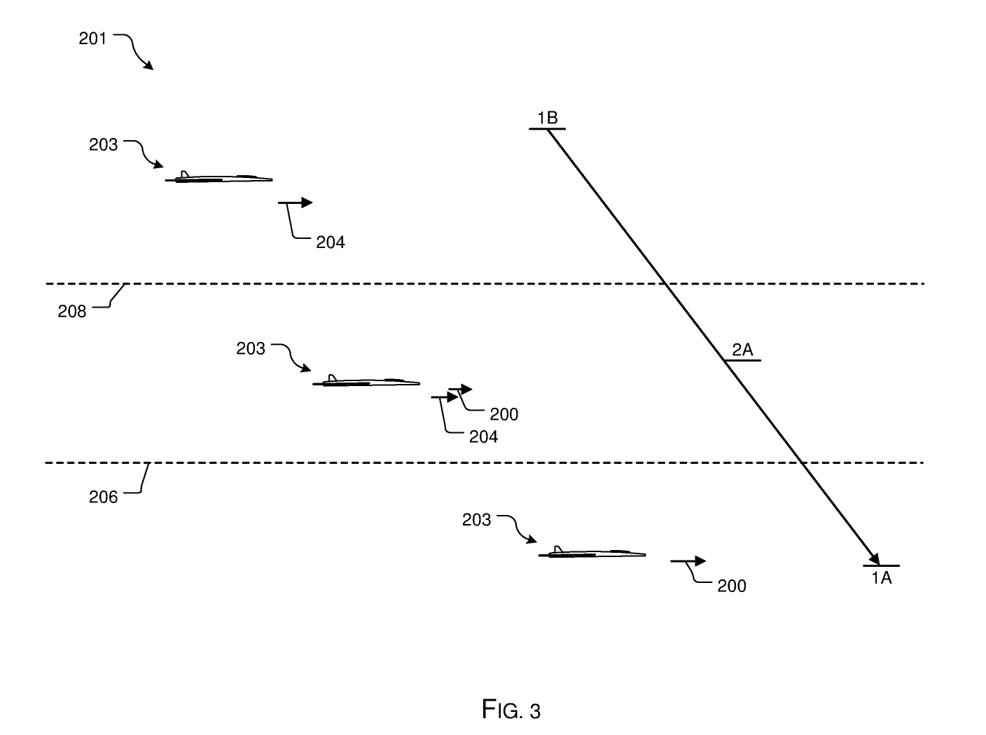

Referring specifically to FIGS. 2 and 3, respective schematics of an aircraft 203 are shown during takeoff and landing flight regimes. The aircraft 203 includes a body 205 having one or more wings 207 secured thereto along with a first engine 213 and a second engine 211 secured to wing 207. In the exemplary embodiment, the engines are secured to the wings; however, it is contemplated having the engines secures to the body of the aircraft in addition to or in lieu of the wings in an alternative embodiment.

As shown in FIG. 2, the aircraft is shown gaining elevation along trajectory 1A-1B. In the preferred embodiment, the first engine 213 produces forward thrust 200, which in turn creates the necessary lift to arrive at an elevation 2A. At the determined elevation 2A, the aircraft transition power from the first engine 213 to the second engine 211 that produces forward thrust 204, which in turn creates the necessary lift to arrive at elevation 1B. The aircraft 203 continues to utilize the second engine 211 during flight until descent, as depicted in FIG. 3. During the landing approach, the aircraft 203 transitions from the second engine thrust to the first engine thrust. It will be appreciated that the preferred embodiment utilizes engine configured at optimal performance during the different flight regimes.

One of the unique features believed characteristic of the present invention is the use of one or more engines configured to create optimal performance at different flight regimes. In the preferred embodiment, the second engine 211 is a scramjet configured to create forward thrust at elevations and speeds reaching at and above Mach 5, while the first engine is a prop, jet, and/or other type of engine configured to achieve optimal performance at flight regimes with a Mach number less that one.

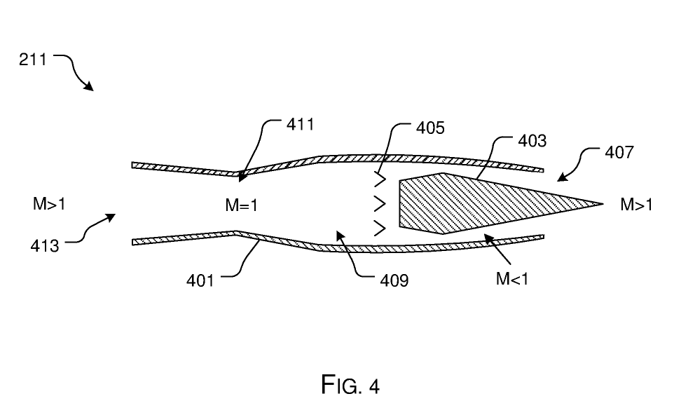

In FIG. 4, a cross-sectional side view of engine 211 is shown having a contoured body 401 with a cone 403 and a plurality of flame holders 405. During use, the air intake at opening 407 is greater that Mach 1, is compressed while traveling between the cone 403 and body 401 to M<1, and passes to the combustion chamber 409 wherein the compressed air is ignited. The heated air passes through a nozzle section 411 where M=1 and through the exit 413 wherein the heated air has increased speeds above Mach 1. It should be noted that for the scramjet technology to achieve desired results, the air passing therethrough should be close to and thereafter above M=1.

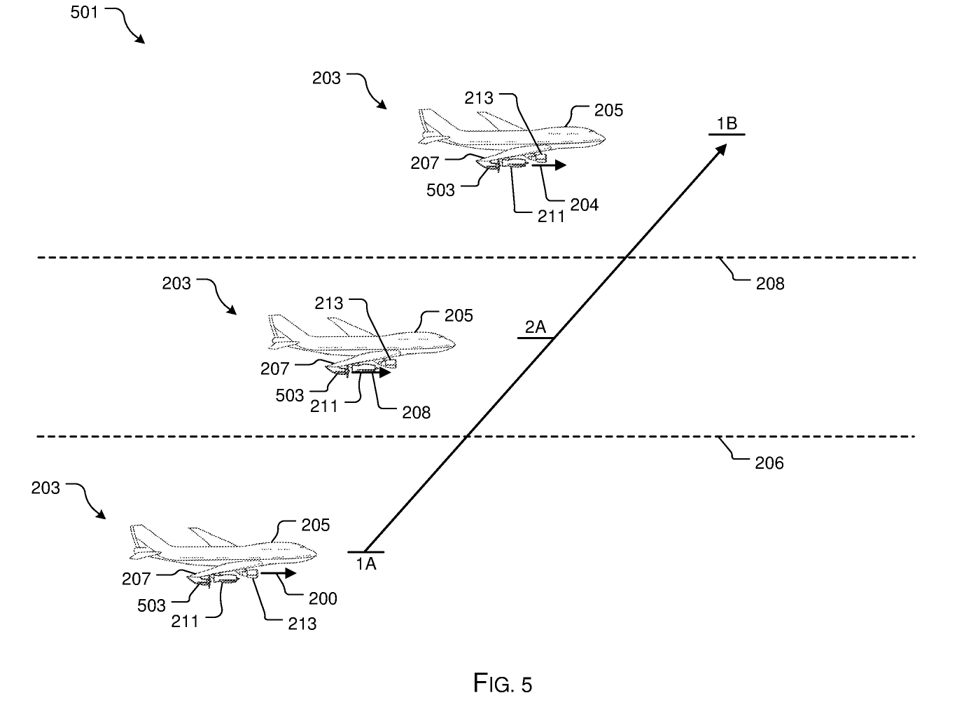

It is also contemplated having an alternative embodiment of system 201 wherein a third engine 503 is utilized to achieve the desired resulted outlined in FIGS. 2 and 3. As shown in FIG. 5, a third engine could be secured to the wing of the aircraft and could create the necessary thrust 208 for forward flight and lift during elevation 2A and be a transitionary engine between the first and second engines.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A hypersonic vehicle, comprising:
a body;
a first engine secured to the body, the first engine is configured to create forward thrust at a first flight regime; and
a second engine secured to the body, the second engine is configured to create forward thrust at a second flight regime;
wherein the hypersonic vehicle transitions between the first engine and the second engine during the first flight regime and the second flight regime.

2. The vehicle of claim 1, further comprising:
a third engine secured to the body, the third engine is configured to create forward thrust at a third flight regime.

3. The vehicle of claim 1, further comprising:
a wing secured to and extending from the body;
wherein the wing creates lift.

4. The vehicle of claim 3, wherein the first engine and the second engine are secured to the wing.

5. The vehicle of claim 1, wherein the second engine is a scramjet.

6. The vehicle of claim 5, wherein the first engine is a jet engine.

7. The vehicle of claim 5, wherein the first engine is a turboprop engine.

8. A hypersonic aircraft, comprising:
a body;
a wing secured to and extending from the body;
a first engine secured to the body, the first engine is configured to create forward thrust at a first flight regime; and
a second engine secured to the body, the second engine is configured to create forward thrust at a second flight regime;
wherein the hypersonic vehicle transitions between the first engine and the second engine during the first flight regime and the second flight regime.

9. The vehicle of claim 8, further comprising:
a third engine secured to the body, the third engine is configured to create forward thrust at a third flight regime.

10. The vehicle of claim 8, wherein the first engine and the second engine are secured to the wing.

11. The vehicle of claim 8, wherein the second engine is a scramjet.

12. The vehicle of claim 11, wherein the first engine is a jet engine.

13. The vehicle of claim 11, wherein the first engine is a turboprop engine.
